(19) United States
(12) Patent Application Publication
(10) Pub. No.: US 2025/0234392 A1
(43) Pub. Date: Jul. 17, 2025

(54) COMMUNICATION CONTROL METHOD

(71) Applicant: KYOCERA Corporation, Kyoto (JP)

(72) Inventor: Masato FUJISHIRO, Yokohama-shi (JP)

(73) Assignee: KYOCERA Corporation, Kyoto (JP)

(21) Appl. No.: 19/170,859

(22) Filed: Apr. 4, 2025

Related U.S. Application Data
(63) Continuation of application No. PCT/JP2023/035825, filed on Oct. 2, 2023.

(30) Foreign Application Priority Data
Oct. 6, 2022 (JP) 2022-161585

(51) Int. Cl. H04W 74/0833; H04W 84/06

(52) U.S. Cl. CPC H04W 74/0833; H04W 84/06

(57) ABSTRACT

In an aspect, a communication control method is used in a cellular communication system. The communication control method includes a step of transmitting, by a network node, a parameter used in a random access procedure to a user equipment. The parameter is a parameter dedicated to the user equipment located at an altitude equal to or higher than a predetermined threshold value.

### RELATED APPLICATIONS

The present application is a continuation based on PCT Application No. PCT/JP2023/035825, filed on Oct. 2, 2023, which claims the benefit of Japanese Patent Application No. 2022-161585 filed on Oct. 6, 2022. The content of which is incorporated by reference herein in their entirety.

### TECHNICAL FIELD

The present disclosure relates to a communication control method in a mobile communication system.

### BACKGROUND

In the specifications of the Third Generation Partnership Project (3GPP) (trade name; the same applies hereinbelow), which is a standardization project for mobile communication systems, an Aerial UE is defined (for example, see Non-Patent Document 1 and Non-Patent Document 2). For example, the Aerial UE can report an altitude or report position information including a vertical velocity and a horizontal velocity. In the 3GPP, communication with the Aerial UE flying in the sky is appropriately supported through such specifications.

### CITATION LIST

### Non-Patent Literature

Non-Patent Document 1:3GPP TS 36.300 V17.1.0 (2022-6)
Non-Patent Document 2:3GPP TS 36.331 V17.1.0 (2022-6)

### SUMMARY

In an aspect, a communication control method is a communication control method in a mobile communication system. The communication control method includes a step of transmitting, by a network node (or a network apparatus), a parameter used in a random access procedure to a user equipment. The parameter is a parameter dedicated to the user equipment located at an altitude equal to or higher than a predetermined threshold value.

### BRIEF DESCRIPTION OF THE DRAWINGS

FIG. 1 is a diagram illustrating a configuration example of a mobile communication system according to a first embodiment.

FIG. 2 is a diagram illustrating a configuration example of a user equipment (UE) according to the first embodiment.

FIG. 3 is a diagram illustrating a configuration example of a base station (gNB) according to the first embodiment.

FIG. 4 is a diagram illustrating a configuration example of a protocol stack of a user plane according to the first embodiment.

FIG. 5 is a diagram illustrating a configuration example of a protocol stack of a control plane according to the first embodiment.

FIG. 6 is a diagram illustrating a cell configuration example according to the first embodiment.

FIG. 7 is a diagram illustrating an operation example according to the first embodiment.

### DESCRIPTION OF EMBODIMENTS

The present disclosure provides interference avoidance in a random access procedure.

A mobile communication system according to an embodiment is described with reference to the drawings. In the description of the drawings, the same or similar parts are denoted by the same or similar reference signs.

### First Embodiment

### Configuration of Mobile Communication System

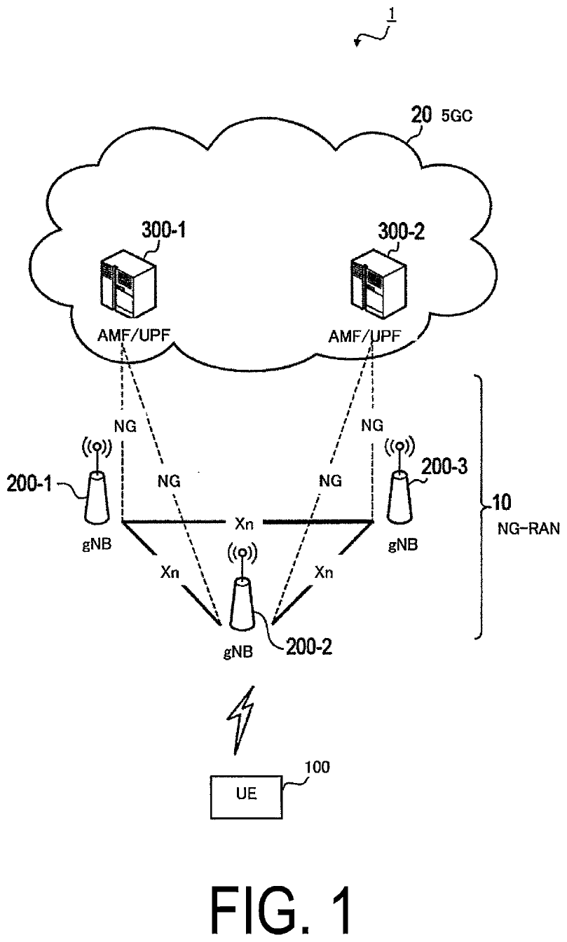

FIG. 1 is a diagram illustrating a configuration of a mobile communication system according to a first embodiment. The mobile communication system 1 complies with the 5th Generation System (5GS) of the 3GPP standard. The description below takes the 5GS as an example, but

Long Term Evolution (LTE) system may be at least partially applied to the mobile communication system. Alternatively, a sixth generation (6G) system may be at least partially applied to the mobile communication system.

The mobile communication system 1 includes User Equipment (UE) 100, a 5G radio access network (Next Generation Radio Access Network (NG-RAN)) 10, and a 5G Core Network (5GC) 20. The NG-RAN 10 will be hereinafter simply referred to as the RAN 10. The 5GC 20 may be simply referred to as the Core Network (CN) 20.

The UE 100 is a mobile wireless communication apparatus. The UE 100 may be any apparatus as long as the UE 100 is used by a user. Examples of the UE 100 include a mobile phone terminal (including a smartphone) and/or a tablet terminal, a notebook PC, a communication module (including a communication card or a chipset), a sensor or an apparatus provided on a sensor, a vehicle or an apparatus provided on a vehicle (Vehicle UE), and a flying object or an apparatus provided on a flying object (Aerial UE).

The NG-RAN 10 includes base stations (referred to as “gNBs” in the 5G system) 200. The gNBs 200 are interconnected via an Xn interface which is an inter-base station interface.

Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency (hereinafter simply referred to as a “frequency”).

Note that the gNB 200 can also be connected to an Evolved Packet Core (EPC) that is an LTE core network. An LTE base station (evolved Node B (eNB)) can also be connected to the 5GC 20. The LTE base station and the gNB 200 can also be connected via an inter-base station interface.

The 5GC 20 includes an Access and Mobility Management Function (AMF) and a User Plane Function (UPF) 300. The AMF performs various types of mobility controls and the like for the UE 100. The AMF manages mobility of the UE 100 by communicating with the UE 100 by using Non-Access Stratum (NAS) signaling. The UPF controls data transfer. The AMF and UPF are connected to the gNB 200 via an NG interface which is an interface between a base station and the core network.

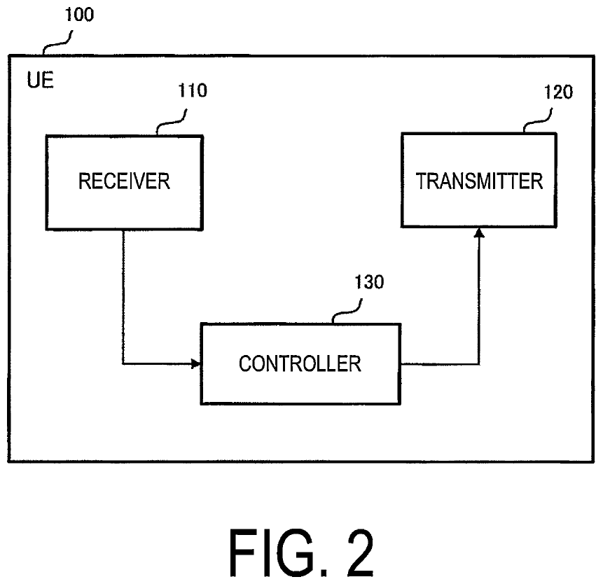

FIG. 2 is a diagram illustrating a configuration example of the user equipment (UE 100) according to the first embodiment. The UE 100 includes a receiver 110, a transmitter 120, and a controller 130. The receiver 110 and the transmitter 120 constitute a wireless communicator that performs wireless communication with the gNB 200.

The receiver 110 performs various types of reception under control of the controller 130. The receiver 110 includes an antenna and a reception device. The reception device converts a radio signal received through the antenna into a baseband signal (a reception signal) and outputs the resulting signal to the controller 130.

The transmitter 120 performs various types of transmission under control of the controller 130. The transmitter 120 includes an antenna and a transmission device. The transmission device converts a baseband signal (a transmission signal) output by the controller 130 into a radio signal and transmits the resulting signal through the antenna.

The controller 130 performs various types of control and processing in the UE 100. Such processing includes processing of respective layers to be described later. The controller 130 includes at least one processor and at least one memory. The memory stores a program to be executed by the processor and information to be used for processing by the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing. Note that the controller 130 may perform all processing or each operation in the UE 100 in each embodiment to be described below.

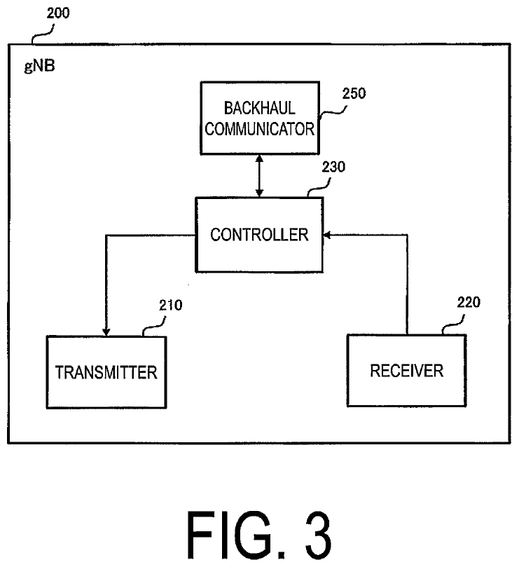

FIG. 3 is a diagram illustrating a configuration of the gNB 200 (base station) according to the first embodiment. The gNB 200 includes a transmitter 210, a receiver 220, a controller 230, and a backhaul communicator 240. The transmitter 210 and the receiver 220 constitute a wireless communicator that performs wireless communication with the UE 100. The backhaul communicator 240 constitutes a network communicator that performs communication with the CN 20.

The transmitter 210 performs various types of transmission under control of the controller 230. The transmitter 210 includes an antenna and a transmission device. The transmission device converts a baseband signal (a transmission signal) output by the controller 230 into a radio signal and transmits the resulting signal through the antenna.

The receiver 220 performs various types of reception under control of the controller 230. The receiver 220 includes an antenna and a reception device. The reception device converts a radio signal received through the antenna into a baseband signal (a reception signal) and outputs the resulting signal to the controller 230.

The controller 230 performs various types of control and processing in the gNB 200. Such processing includes processing of respective layers to be described later. The controller 230 includes at least one processor and at least one memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing. The controller 230 may perform all of the processing and operations in the gNB 200 in each embodiment to be described below.

The backhaul communicator 240 is connected to a neighboring base station via an Xn interface which is an inter-base station interface. The backhaul communicator 240 is connected to the AMF/UPF 300 via an NG interface between a base station and the core network. Note that the gNB 200 may include a Central Unit (CU) and a Distributed Unit (DU) (i.e., functions are divided), and both units may be connected via an F1 interface that is a fronthaul interface.

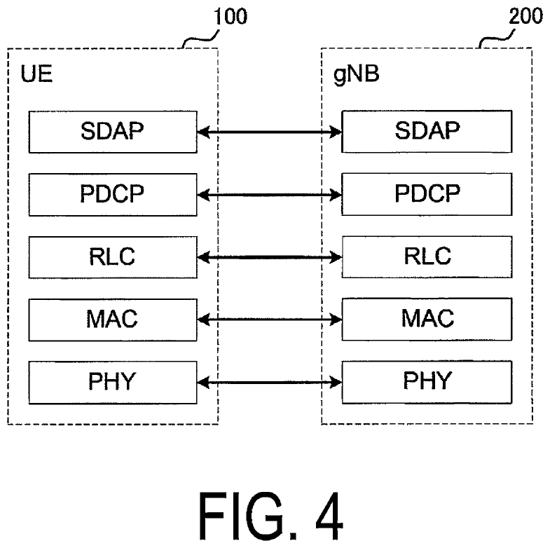

FIG. 4 is a diagram illustrating a configuration of a protocol stack of a radio interface of a user plane handling data.

A radio interface protocol of the user plane includes a Physical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs coding and decoding, modulation and demodulation, antenna mapping and demapping, and resource mapping and demapping. Data and control information are transmitted between the PHY layer of the UE 100 and the PHY layer of the gNB 200 via a physical channel. Note that the PHY layer of the UE 100 receives downlink control information (DCI) transmitted from the gNB 200 over a physical downlink control channel (PDCCH). Specifically, the UE 100 blind decodes the PDCCH using a radio network temporary identifier (RNTI) and acquires successfully decoded DCI as DCI addressed to the UE 100. The DCI transmitted from the gNB 200 is appended with CRC parity bits scrambled by the RNTI.

The MAC layer performs priority control of data, retransmission processing through hybrid ARQ (HARQ: Hybrid Automatic Repeat reQuest), a random access procedure, and the like. Data and control information are transmitted between the MAC layer of the UE 100 and the MAC layer of the gNB 200 via a transport channel. The MAC layer of the gNB 200 includes a scheduler. The scheduler decides transport formats (transport block sizes, Modulation and Coding Schemes (MCSs)) in the uplink and the downlink and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between an IP flow as the unit of Quality of Service (QOS) control performed by a core network and a radio bearer as the unit of QoS control performed by an Access Stratum (AS). Note that, when the RAN is connected to the EPC, the SDAP need not be provided.

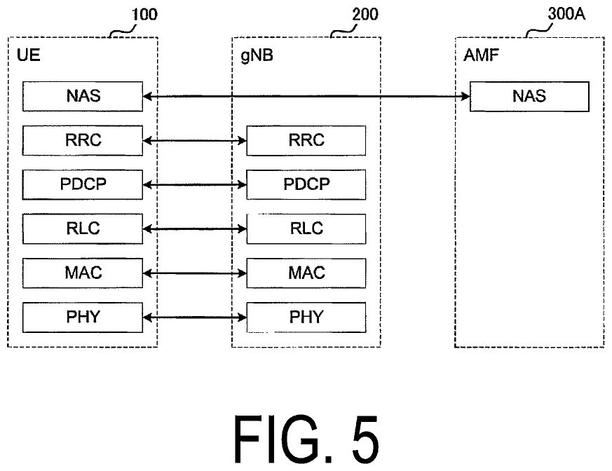

FIG. 5 is a diagram illustrating a configuration of a protocol stack of a radio interface of a control plane handling signaling (control signal).

The protocol stack of the radio interface of the control plane includes a Radio Resource Control (RRC) layer and a Non-Access Stratum (NAS) layer instead of the SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When a connection (RRC connection) between the RRC of the UE 100 and the RRC of the gNB 200 is present, the UE 100 is in an RRC connected state. When no connection (RRC connection) between the RRC of the UE 100 and the RRC of the gNB 200 is present, the UE 100 is in an RRC idle state. When the connection between the RRC of the UE 100 and the RRC of the gNB 200 is suspended, the UE 100 is in an RRC inactive state.

The NAS, which is located above the RRC layer, performs session management, mobility management, and the like. NAS signaling is transmitted between the NAS of the UE 100 and the NAS of the AMF 300. Note that the UE 100 includes an application layer other than the protocol of the radio interface. A layer lower than the NAS is referred to as an Access Stratum (AS).

### UAV

An unmanned aerial vehicle (Unmanned Aerial Vehicle or Uncrewed Aerial Vehicle (UAV). An “unmanned aerial vehicle” may be referred to as a “UAV” below) according to the first embodiment will be described.

The UAV is generally an unmanned aircraft, such as a drone. However, in the first embodiment, a UE located at an altitude equal to or higher than a predetermined threshold value (or exceeding the predetermined threshold value) is referred to as a UAV. The UAV may be a UE capable of performing wireless communication with the gNB 200 while flying in the sky in an unmanned manner like an unmanned aircraft. The UAV may be provided to an unmanned aircraft. The UAV may be provided to a manned aircraft. For example, a UE owned by a user on board of an aircraft, while the aircraft is flying at an altitude equal to or higher than a predetermined threshold value, may also be a UAV. The UAV may be a UAV UE. The UAV may be an Aerial UE. The UAV may be distinguished from a UE that is used on the ground. However, when not particularly distinguished from the UE, the UAV may be included in a UE as an example of the UE. In this case, the UAV and the UE may collectively be referred to as the UE. The configuration example of the UE 100 illustrated in FIG. 2 may represent a configuration example of the UAV.

In the 3GPP, a function for supporting an Aerial UE is defined as follows, for example.

First, an Aerial UE can report its altitude. For example, the Aerial UE can report the altitude when its altitude becomes equal to or higher than or equal to or lower than a threshold value. At this time, the Aerial UE can also report position information. The position information may also include a horizontal velocity and a vertical velocity of the Aerial UE.

Second, a network (E-UTRAN) of the LTE system can request the Aerial UE to report flight path information. The flight path information represents a waypoint (passing point information or location point information) on a path of the Aerial UE. The flight path information may include a number of waypoints. The waypoint is represented as three-dimensional position information. The Aerial UE may report time information (time stamp) for each waypoint being included in the flight path information.

Third, whether an Aerial UE is supported (or whether to allow the UE to function as an Aerial UE) is included in subscription information for each user. The subscription information is stored for each user on a Home Subscriber Server (HSS) in the LTE system. Whether the Aerial UE is supported is included in the subscription information. The subscription information is transmitted from the HSS to an eNB that is a base station in the LTE system under control of a Mobility Management Entity (MME). The eNB may recognize whether the UE is allowed to function as an Aerial UE.

Fourth, an event H1 and an event H2 can be used as a trigger condition for a measurement report. The event H1 represents an event condition when the altitude of the Aerial UE exceeds the threshold value. On the other hand, the event H2 represents an event condition when the altitude of the Aerial UE falls below the threshold value. These event conditions are each determined whether the condition is met by using a hysteresis value, an offset value, and a threshold value in addition to the altitude.

As described above, matters defined in the 3GPP are based on the assumption that the Aerial UE (i.e., the UAV) is used in the LTE system.

On the other hand, in the 3GPP, discussion on introduction of the UAV in New Radio (NR) has begun. With regard to the UAV, agreement has been made in the 3GPP. The agreement includes to use the above-mentioned event H1 and event H2, to report an altitude, a position, and a velocity of the UAV, to report a flight path plan.

### Terrestrial Cell and Sky Cell

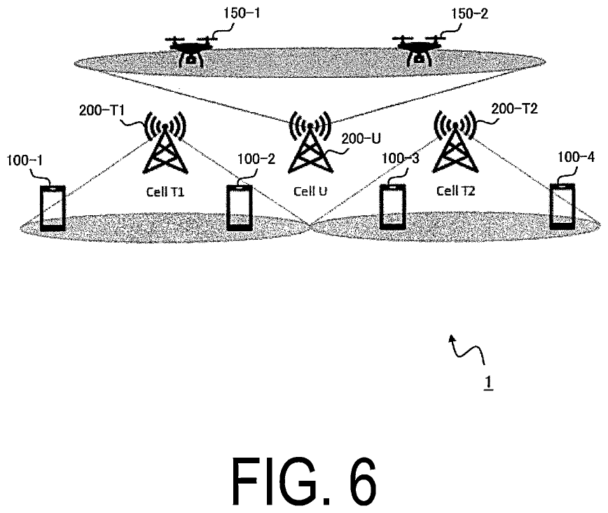

For example, it is assumed that a terrestrial cell and a sky cell coexist in a network. FIG. 6 is a diagram illustrating a cell configuration example of the case described above.

As illustrated in FIG. 6, a mobile communication system 1 includes terrestrial cells and a sky cell. In the example illustrated in FIG. 6, the terrestrial cells are constituted of a gNB 200-T1 and a gNB 200-T2, respectively, and the sky cell is constituted of a gNB 200-U. FIG. 6 illustrates an example in which UEs 100-1 to 100-4 each perform wireless communication with either the gNB 200-T1 or the 200-T2 in the terrestrial cell, and UAVs 150-1 and 150-2 each perform wireless communication with the gNB 200-U in the sky cell.

Here, in order for the UEs 100-1 to 100-4 to appropriately perform wireless communication in the terrestrial cells and in order for the UAVs 150-1 and 150-2 to appropriately perform wireless communication in the sky cell, the following two scenarios are assumed.

In the first scenario, a dedicated frequency is assigned to the sky cell, and different frequencies are used in the terrestrial cell and the sky cell. In the first scenario, for example, since wireless communication by the UAVs 150-1 and 150-2 and wireless communication by the UEs 100-1 to 100-4 is performed by using different frequencies, interference between the two wireless communications can be avoided.

On the other hand, in the second scenario, the same frequency (or the same frequency range) is used in the terrestrial cell and the sky cell. In the second scenario, since the frequency is shared by the terrestrial cell and the sky cell, frequency resources need not be specifically increased. Therefore, in the second scenario, effective use of frequency resources can be achieved.

### Communication Control Method According to First Embodiment

A problem specific to the UAV is that the influence of the interference is greater in wireless communication by the UAV 150 than in wireless communication by the UE 100 on the ground. For example, as illustrated in FIG. 6, assume that the UAV 150-1 and the UAV 150-2 (hereinafter, may be referred to as a UAV 150 when the UAV 150-1 and the UAV 150-2 are not distinguished) located in the sky perform uplink communication. In such a case, the radio signal transmitted from the UAV 150 may reach not only a serving cell and its neighboring cell but an even wider range. When the UE 100 on the ground uses the same frequency as the UAV 150, a signal from the UAV 150 may interfere with a signal from the UE 100 on the ground. In the discussion from now on in the 3GPP, it is assumed that various interference avoidance measures are taken for the UAV 150 in the RRC connected state.

On the other hand, even when the UAV 150 performs the random access procedure, the UE on the ground performing the random access procedure using the same frequency at the same time may cause an interference as in the above-described case.

However, there is currently no measure to avoid the interference caused by the UAV 150 performing the random access procedure.

Therefore, the first embodiment provides interference avoidance in a random access procedure.

Therefore, in the first embodiment, an example is described in which a parameter used in the random access procedure (hereinafter, also referred to as a “RACH” parameter) is a parameter dedicated to the UAV 150. To be specific, a base station (for example, the gNB 200) transmits a parameter used in a random access procedure to a user equipment (for example, the UE 100 or the UAV 150). Here, the parameter is a parameter dedicated to the user equipment (for example, the UAV 150) located at an altitude equal to or higher than a predetermined threshold value.

As described above, in the first embodiment, the gNB 200 can configure the RACH parameter dedicated to the UAV 150 for the UAV 150. Therefore, when the UAV 150 performs the random access procedure, for example, a transmission power for the random access preamble can be appropriately configured and the number of retransmissions of the random access preamble can be appropriately configured. Such a configuration can avoid interference with the UE 100 caused by the UAV 150 performing the random access procedure.

### Example of Parameters Used in Random Access Procedure

An example of the parameter used in the random access procedure is described.

The random access procedure is performed when the UE 100 in an RRC idle state makes an Initial access to the network, when the UE in an RRC inactive state performs an RRC Connection Resume procedure, when the UE 100 performs an RRC Connection Re-establishment procedure, and the like. The random access procedure allows the UE 100 to establish uplink synchronization with the gNB 200 (or the cell).

First, examples of the parameter used in the random access procedure include a parameter used to transmit a PRACH preamble. The PRACH preamble is a signal transmitted first by the UE 100 in the random access procedure. The parameter is used by performing the following transmission control on the PRACH preamble.

That is, the UE 100 initially sets values for predetermined variables (such as preamble transmission counter, preamble power ramping counter, and preamble power ramping step). Among the predetermined variables, the preamble transmission counter is set using a PRACH transmissions maximum number parameter (preambleTransMax). The PRACH transmissions maximum number parameter represents a maximum number of PRACH preamble transmissions. Among the predetermined variables, the preamble power ramping step may be set using a transmission power ramping step parameter (powerRampingStep). The transmission power ramping step parameter is a parameter that is incremented each time the PRACH preamble is retransmitted.

Next, the UE 100 sets the preamble reception target power (PREAMBLE_RECEIVED_TARGET_POWER) for the RACH preamble using the predetermined variable, a preamble reception target power parameter (preambleReceivedTargetPower), and the like. Since the preamble reception target power is the target reception power of the gNB 200 side, the UE 100 calculates the transmission power for the PRACH preamble by calculating a path loss to the gNB 200. The UE 100 transmits the PRACH preamble with the calculated transmission power.

As described above, examples of the parameter used to transmit the PRACH preamble include the PRACH transmission maximum number parameter (preambleTransMax), the transmission power ramping step parameter (powerRampingStep), and the preamble reception target power parameter (preambleReceivedTargetPower).

Second, examples of the parameter used in the random access procedure includes a parameter used to retransmit the PRACH preamble. The parameters used to transmit the PRACH preamble described above are also used to retransmit the PRACH preamble. Further, examples of the parameter used to retransmit the PRACH preamble include a backoff time parameter (backoff time). The backoff time represents, for example, a time until the PRACH preamble is retransmitted. The backoff time parameter is configured as follows. That is, when the UE 100 receives a Random Access Response (RAR) (Msg2) including a MAC sub PDU with a backoff indication after transmitting the PRACH preamble, the UE 100 sets a preamble backoff variable (PREAMBLE_BACKOFF). The UE 100 obtains the preamble backoff variable by multiplying a value included in a BI field of the MAC sub PDU by a scaling factor (SCALING_FACTOR_BI). The backoff time parameter is configured using a random number from “0” to the preamble backoff variable.

As described above, examples of the parameter used to retransmit the PRACH preamble include, for example, the PRACH transmission maximum number parameter (preambleTransMax), the transmission power ramping step parameter (powerRampingStep), the preamble reception target power parameter (preambleReceivedTargetPower), and the backoff time parameter (backoff time).

Third, examples of the parameter used in the random access procedure include a parameter used when the UE 100 receives the random access response (Msg2). Examples of the parameter used to receive the random access response include, for example, an RAR receive window parameter (ra-ResponseWindow). The RAR receive window parameter is, for example, a parameter representing a time window for monitoring a random access response. When the UE 100 cannot receive the random access response within the time window indicated by the RAR receive window parameter, the UE 100 retransmits the PRACH preamble until the backoff time (backoff time) elapses. On the other hand, when the UE 100 receives the random access response within the time window indicated by the RAR receive window parameter, the UE 100 stops the RAR receive window parameter.

Note that the PRACH transmission maximum number parameter (preambleTransMax), the transmission power ramping step parameter (powerRampingStep), the preamble reception target power parameter (preambleReceivedTargetPower), and the RAR receive window parameter (ra-ResponseWindow) are included in an information element (RACH-ConfigGeneric). The RACH-ConfigGeneric is an information element included in system information (SIB1) broadcast from the gNB 200. The RACH-ConfigGeneric is used to specify the parameters used in the random access procedure.

### Example of Operation according to First Embodiment

An example of an operation according to the first embodiment will be described.

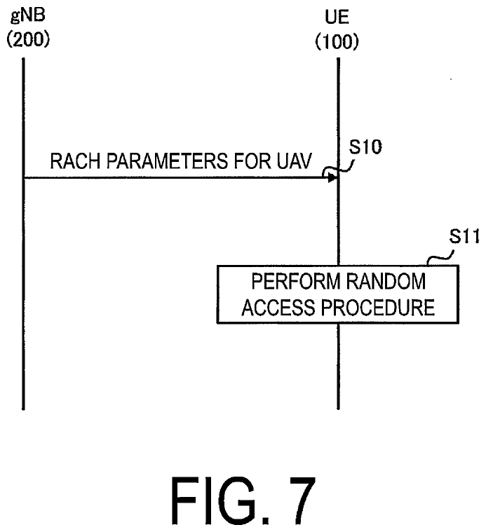

FIG. 7 is a diagram illustrating an operation example according to the first embodiment.

As illustrated in FIG. 7, in step S10, the gNB 200 transmits the RACH parameter dedicated to the UAV 150.

First, the RACH parameter dedicated to UAV 150 is associated with information representing the sky. The information representing the sky may be a predetermined threshold value for identifying the sky. The predetermined threshold value is a threshold values for identifying whether the UE 100 is in the sky or on the ground, and is, for example, an altitude threshold value. When the number of predetermined threshold values is one, two layers of “sky” and “ground” can be configured corresponding to being higher or lower than the threshold value. The number of predetermined threshold values may be two or more. For example, when the number of predetermined threshold values is two, three layers of “high altitude”, “low altitude”, and “ground” can be configured. Alternatively, the information representing the sky may be information representing a state indicating that the UE 100 is located in the “sky” (for example, “sky”). The association indicates that the RACH parameter is used in by the UE 100 (that is, the UAV 150) located in the sky.

Second, the RACH parameter dedicated to the UAV 150 may be at least one parameter included in the above-described information element (RACH-ConfigGeneric). Specifically, the parameter may be, for example, any one of the following.
(A1) PRACH transmission maximum number parameter (preambleTransMax)
(A2) Transmission power ramping step parameter (powerRampingStep)
(A3) Preamble reception target power parameter (preambleReceivedTargetPower)
(A4) RAR receive window parameter (ra-ResponseWindow) For example, when the gNB 200 configures the preamble reception target power parameter (preambleReceivedTargetPower) dedicated to the UAV 150 to have a value lower than the preamble reception target power parameter for the UE 100 on the ground, the transmission power for the PRACH preamble transmitted from the UAV 150 can be made lower than the transmission power for the PRACH preamble transmitted from the UE 100 on the ground. This also makes it possible to avoid interference when the random access procedure is performed in the UAV 150. The other parameters can also be configured to have values lower (or smaller) than the parameters for the UE 100 on the ground, for example, thereby, interference can be avoided when the random access procedure is performed in the UAV 150.

The RACH parameter dedicated to the UAV 150 may be a backoff time parameter (backoff time). Alternatively, the RACH parameter dedicated to the UAV 150 may be a parameter representing an upper limit time of the backoff time. The backoff time itself is configured to be a random number from “0” to the preamble backoff variable (PREAMBLE_BACKOFF) as described above. However, by configuring an upper limit for the random number, the backoff time can be prevented from being set longer than necessary. By this means, for example, the backoff time is not set longer than necessary when the PRACH preamble is retransmitted from the UAV 150, thus the PRACH preamble is not retransmitted from the UAV 150 for a longer time than necessary, and interference can also be avoided when the random access procedure is performed in the UAV 150. Alternatively, the RACH parameter dedicated to the UAV 150 may be a parameter representing the maximum value of the backoff time. The maximum value of the backoff time indicates that the backoff time is not configured using a random number but a designated maximum value is configured as the backoff time. Alternatively, the RACH parameter dedicated to the UAV 150 may be a parameter representing a lower limit value of the backoff time (for example, “0”). With the lower limit value, the backoff time configured by using the random number can be always set to “0”. By doing this, for example, the gNB 200 can control the UAV 150 to wait for a certain period of time for retransmission of the PRACH preamble, and to avoid interference with the random access procedure of the UE 100 on the ground.

Thus, the parameter value included in the RACH parameter dedicated to the UAV 150 is a parameter value different from the parameter value for the UE 100 on the ground. This may result in the RACH parameter dedicated to the UAV 150.

Note that the above-described (A1) to (A4) and the backoff time parameter may be transmitted in broadcast using the system information (SIB).

In step S11, the UE 100 performs the random access procedure using the RACH parameter dedicated to the UAV 150 at an altitude equal to or higher than a predetermined threshold value. Note that the altitude of the UE 100 may be measured by a sensor provided to the UE 100. The altitude of the UE 100 may be measured by a distance sensor (radar, lidar, or the like) provided to the UE 100. Note that the altitude may be represented in sea level. The altitude may be represented in elevation. The altitude may be represented in height from the ground.

Note that the gNB 200 may transmit some of the above-described RACH parameters dedicated to the UAV 150. In this case, the UE 100 may perform the random access procedure by applying some of the RACH parameters dedicated to the UAV 150 and applying the RACH parameters for the ground (or conventional) use to the other RACH parameters that are not transmitted.

### OTHER EMBODIMENTS

The operation flows described above can be separately and independently implemented, and also be implemented in combination of two or more of the operation flows. For example, some steps of one operation flow may be added to another operation flow or some steps of one operation flow may be replaced with some steps of another operation flow. In each flow, all steps may not be necessarily performed, and only some of the steps may be performed.

Although the example in which the base station is an NR base station (gNB) has been described in the embodiments and examples described above, the base station may be an LTE base station (eNB) or a 6G base station. The base station may be a relay node such as an Integrated Access and Backhaul (IAB) node. The base station may be a DU of the IAB node. The UE 100 may be a Mobile Termination (MT) of the IAB node.

The term “network node” mainly means a base station, but may also mean a core network apparatus or a part (CU, DU, or RU) of the base station.

A program causing a computer to execute each of the processing performed by the UE 100 or the gNB 200 may be provided. The program may be recorded in a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM.

Circuits for executing processing performed by the UE 100 or the gNB 200 may be integrated, and at least a part of the UE 100 and the gNB 200 may be implemented as a semiconductor integrated circuit (chipset, System on a chip (SoC)).

The phrases “based on” and “depending on/in response to” used in the present disclosure do not mean “based only on” and “only depending on/in response to” unless specifically stated otherwise. The phrase “based on” means both “based only on” and “based at least in part on”. The phrase “depending on” means both “only depending on” and “at least partially depending on”. The terms “include”, “comprise” and variations thereof do not mean “include only items stated” but instead mean “may include only items stated” or “may include not only the items stated but also other items”. The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a”, “an”, and “the” are added in the present disclosure through translation, these articles include the plural unless clearly indicated otherwise in context.

The embodiments have been described above in detail with reference to the drawings, but specific configurations are not limited to those described above, and various design variations can be made without departing from the gist of the present disclosure. All or some of the embodiments, operations, processes, and steps may be combined without being inconsistent.

### Supplements

### Supplementary Note 1

A communication control method in a mobile communication system, the communication control method including:
a step of transmitting, by a network node, a parameter used in a random access procedure to a user equipment,
wherein the parameter is a parameter dedicated to the user equipment located at an altitude equal to or higher than a predetermined threshold value.

### Supplementary Note 2

The communication control method according to supplementary note 1, wherein the parameter is a parameter used when the user equipment transmits a PRACH preamble.

### Supplementary Note 3

The communication control method according to supplementary note 1 or 2, wherein the parameter is a parameter used when the user equipment retransmits a PRACH preamble.

### Supplementary Note 4

The communication control method according to any one of supplementary notes 1 to 3, wherein the parameter is a parameter used when the user equipment receives a random access response.

### REFERENCE SIGNS

1: Mobile communication system
20: 5GC
100: UE
110: Receiver 130: Controller
150: UAV
200: gNB
210: Transmitter
230: Controller

1. A communication control method in a mobile communication system, the communication control method comprising:
receiving, by a user equipment from a network node, a parameter used in a random access procedure, wherein
the parameter is a parameter dedicated to the user equipment located at an altitude equal to or higher than a predetermined threshold value.

2. The communication control method according to claim 1, wherein
the parameter is a parameter used when the user equipment transmits a PRACH preamble.

3. The communication control method according to claim 1, wherein
the parameter is a parameter used when the user equipment retransmits a PRACH preamble.

4. The communication control method according to claim 1, wherein
the parameter is a parameter used when the user equipment receives a random access response.

5. The communication control method according to claim 4, wherein
the parameter is a parameter indicating a time window for monitoring a random access response.

6. A user equipment in a mobile communication system, the user equipment comprising
a receiver configured to receive from a network node, a parameter used in a random access procedure, wherein
the parameter is a parameter dedicated to the user equipment located at an altitude equal to or higher than a predetermined threshold value.
